(19) United States
(12) Patent Application Publication
(10) Pub. No.: US 2011/0113259 A1
(43) Pub. Date: May 12, 2011

(54) RE-KEYING DURING ON-LINE DATA MIGRATION

(75) Inventors: Prakash B. BILODI, Santa Clara, CA (US); Nipen N. MODY, Fremont, CA (US); Nghiep V. TRAN, San Jose, CA (US)

(73) Assignee: BROCADE COMMUNICATION SYSTEMS, INC., San Jose, CA (US)

(21) Appl. No.: 12/615,408

(22) Filed: Nov. 10, 2009

(51) Int. Cl. G06F 12/14; G06F 12/00; G06F 12/02

(52) U.S. Cl. 713/193; 711/165; 711/E12.001; 711/E12.092

(57) ABSTRACT

A method of migrating data comprises migrating source encrypted data from a source storage device to a target storage device and re-keying while migrating the source encrypted data. The method further comprises while re-keying and migrating the source encrypted data, performing an access request to the source encrypted data apart from the migrating and re-keying.

### CROSS-REFERENCE TO RELATED APPLICATIONS

This disclosure contains subject matter that may be related subject matter disclosed in U.S. patent application Ser. No. 12/542,438 entitled “Re-Keying Data In Place,” filed on Aug. 17, 2009 and U.S. patent application Ser. No. 12/183,581 entitled “Data Migration Without Interrupting Host Access,” filed Jul. 31, 2008, both of which are incorporated herein by reference.

### BACKGROUND

Data migration between storage devices may be necessary for a variety of reasons. For example, storage devices are frequently replaced because users need more capacity or performance. Additionally, it may be necessary to migrate data residing on older storage devices to newer storage devices. In “host-based” data migration, host CPU bandwidth and host input/output (“I/O”) bandwidth are consumed for the migration at the expense of other host application, processing, and I/O requirements. Also, the data marked for migration is unavailable for access by the host during the migration process.

In some instances, the data to be migrated may encrypted. Most encryption processes use an encryption key. The key being obtained by an unauthorized entity may comprise the security of the data.

### SUMMARY

Systems, devices, and methods to overcome these and other obstacles to data migration are described herein. For example, a method of migrating data comprises migrating source encrypted data from a source storage device to a target storage device and re-keying while migrating the source encrypted data. The method further comprises while re-keying and migrating the source encrypted data, performing an access request to the source encrypted data apart from the migrating and re-keying.

In accordance with another embodiment, a device comprises a migration module, an encryption module, and an access request controller. The migration module is configured to migrate encrypted data from a first storage location device to a second storage device. The encryption module is configured to re-key encrypted data as the encrypted data is being migrated. The access request controller is configured to receive write access requests for the encrypted data from a host while the data is being rekeyed and migrated and to send the write access requests to the first storage device and the second storage device.

In accordance with yet another embodiment, a method comprises migrating source encrypted data, by a migration device, from a source storage device to a target storage device and re-keying while migrating the source encrypted data. While re-keying and migrating the source encrypted data, the method further comprises receiving and holding write access requests to the source encrypted data.

These and other features and advantages will be more clearly understood from the following detailed description taken in conjunction with the accompanying drawings and claims.

### BRIEF DESCRIPTION OF THE DRAWINGS

For a more complete understanding of the present disclosure, reference is now made to the accompanying drawings and detailed description, wherein like reference numerals represent like parts:

FIG. 1A illustrates a system for migrating data constructed in accordance with various embodiments;

FIG. 1B illustrates a migration device in accordance with various illustrative embodiments;

FIG. 2 illustrates a method for re-keying and migrating data in accordance with various embodiments;

FIG. 3 illustrates a method for re-keying encrypted data during a migration process in accordance with various embodiments; and

FIG. 4 illustrates an electronic device suitable for implementing one or more embodiments described herein in accordance with various embodiments.

### NOTATION AND NOMENCLATURE

Certain terms are used throughout the following claims and description to refer to particular components. As one skilled in the art will appreciate, different entities may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean an optical, wireless, indirect electrical, or direct electrical connection. Thus, if a first device couples to a second device, that connection may be through an indirect electrical connection via other devices and connections, through a direct optical connection, etc. Additionally, the term “system” refers to a collection of two or more hardware components, and may be used to refer a combination of network elements.

The term “key” refers to a value (e.g., an alphanumeric value) that is used to encrypt and/or decrypt data, and thus may also be referred to herein as an “encryption key” or a “decryption key.”

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

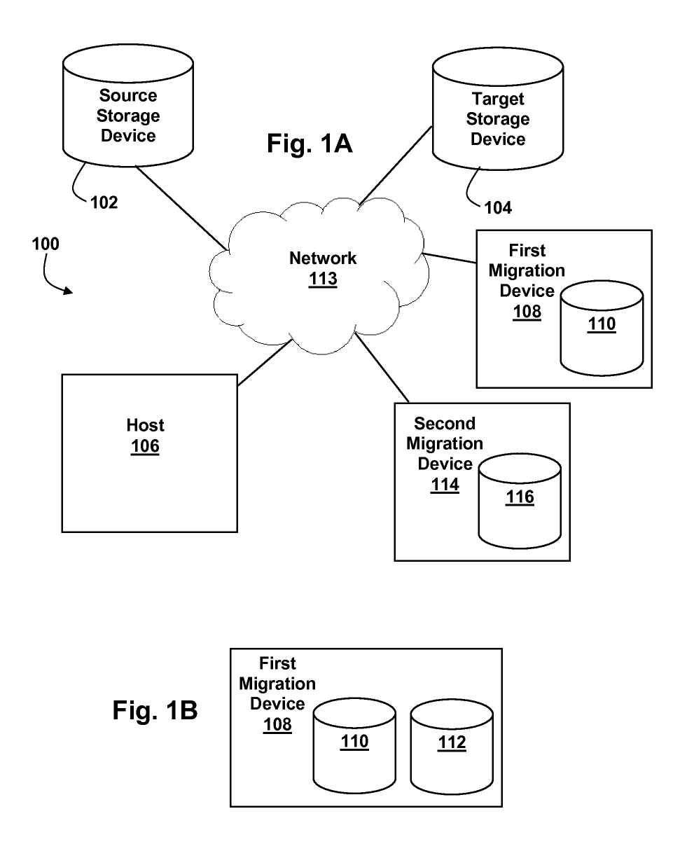

FIG. 1A illustrates a system 100 including a source storage device 102, a target storage device 104, a host 106, a first migration device 108, and a second migration device 114. In at least one embodiment, the first migration device is a network device such as a switch, a personal computer (PC)-based appliance or any other type of electronic device. The second migration device 114 also may be a network device such as a switch, a PC-based appliance, or other type of electronic device.

The source storage device 102, the target storage device 104, the host 106, and the first and second migration devices 108,114 are coupled together via a network 113 such as a packet-switched network. In some embodiments, the network 113 may comprise a Fibre Channel over Ethernet, Convergence Enhanced Ethernet, IP/Ethernet, or combinations or hybrids thereof, without limitation.

The first migration device 108 includes a first virtual storage device 110, created during configuration of the first migration device 108. Virtual storage device 100 may be a software emulation of storage device. Here, the first virtual storage device 110 runs on the first migration device 108 (e.g., is created by software stored in memory and executed by a processor contained in the migration device 108).

The first migration device 108 is configured to migrate data between devices, here, between the source storage device 102 and the target storage device 104. Migrating data includes any one or more of: pre-copy processing, copying the data, and post-copy processing. In accordance with various embodiments, the data being migrated comprises encrypted data, that is, data that has been encrypted and stored on the source storage device 102 in encrypted form. A key was used to encrypt the data stored on the source storage device 102. The host 106 (or other network device) may have been used to encrypt and store the encrypted data on the source storage device 102. While migrating the encrypted data from the source storage device 102 to the target storage device 104, the encrypted data is “re-keyed.” Re-keying encrypted data comprises decrypting the encrypted data and then re-encrypting the data with a new key. The new key used to re-key the data preferably is different than the key used to encrypt the data in the first place. Re-keying the data during the migration helps to improve the security of the data. Further, in accordance with various embodiments, the data being re-keyed and migrated continues to be made available to, for example, host 106. As such, the migration of the data is referred to as “on-line” migration. Embodiments disclosed herein thus implement a re-keying of data during on-line migration of the data.

The first migration device 108 copies the data (which may be encrypted) by reading encrypted data from the source storage device 102 via network 113 and writing the encrypted data to the target storage device 104 via the network 113. In at least one embodiment, migrating encrypted data also includes deleting the encrypted data from the source storage device 102 as part of post-copy processing.

The host 106 is typically a computer coupled to network 113 and configured to manipulate the data, and may request data from the source storage device 102 during the migration process via read and write access requests that are received, for example, by the first migration device 108. The first virtual storage device 110 in first migration device 108 is configured to receive the write access requests during migration of the data and send the write access requests to the source storage device 102 and the target storage device 104 via network 113. The first virtual storage device 110 is also configured to receive read access requests from host 106 via network 113 during migration of the data by the first migration device 108 between storage devices 102, 104, and send, preferably in real-time, the read access requests to the source storage device 102. Accordingly, the first virtual storage device 110 permits a host (e.g., host 106) to continue to issue writes and reads to data on the source storage device 102 even though such data is actively being migrated to the target storage device 104 by the first migration device 110.

The first migration device 108 further includes an alternate virtual storage device 112 as illustrated in the embodiment of FIG. 1 B. The alternate virtual storage device 112 is preferably created when there are multiple data access paths to the source storage device 102 from the first migration device 108. The alternate virtual storage device 112 is preferably used to provide data path redundancy and load balancing both to the host 106's read/write requests as well as for the migrations facilitated by the first migration device 108. The first virtual storage device 110 is configured to fail over to the alternate virtual storage device 112 upon an error, e.g., a migration error, read error, write error, etc. Any suitable technique (e.g., heartbeat messages) can be employed to detect a failure of the first virtual storage device 110. Upon such an error, the data already migrated need not be migrated again. Rather, the alternate virtual storage device 112 will assume the responsibilities of the first virtual storage device 110 and continue the migration preferably beginning from the point of error.

The first migration device 108 is configured to be coupled to and decoupled from the source storage device 102, the target storage device 104, and/or the network 113 without disrupting network communication. In one embodiment, the first migration device 108 is coupled to the network 113 in order to migrate data, and once migration is complete, the first migration device 108 is decoupled from the network 113. Such coupling and decoupling may take the form of a physical attachment and detachment, or a logical connect/disconnect. However, the first migration device 108 need not be decoupled from the network 113 and instead, can transition to an idle state or other state in which the device 108 does not provide migration services. After migration, the host 106 may be configured to access the data on the target storage device 104, and the data on the source storage device 102 may be deleted if desired by, for example, the first migration device 108. Contrastingly, if desired, the host 106 may continue to access the data on the source storage device 102 during the migration, and any write requests will also be sent to the target storage device 104 to maintain data consistency. Such a scenario may occur when the target storage device 104 is used as a backup of the source storage device 102. After consistency is verified, a full copy snapshot of the target storage device 104 may be presented to another host. As such, the original host is decoupled from the target storage device and continues to write to the source storage device 102.

In an exemplary embodiment, the source storage device 102 and the target storage device 104 use Fibre Channel Protocol (“FCP”). FCP is a transport protocol that predominantly transports Small Computer System Interface (“SCSI”) protocol commands over Fibre Channel networks.

Referring still to FIG. 1, to access data on the source storage device 102, the host 106 sends access requests via network 113 targeting the source storage device 102. Access requests include read access requests and write access requests if the data is to be read or written to, respectively. Access to the data by the host 106 should not be interrupted during migration of the data from source storage device 102 to target storage device 104; thus, the source storage device 102 is disassociated from the host 106 such that the host 106 sends the access requests for the data to the first virtual storage device 110 instead. Consider an example where the source storage device 102, the target storage device 104, and the host 106 communicate using FCP, the first migration device is 108 is a Fibre Channel switch, and the system 100 is a Fibre Channel fabric. Accordingly, the source storage device 102 is removed from a Fibre Channel zone that previously included the source storage device 102, the first migration device 108, and the host 106. Preferably, removing the source storage device 102 from the zone causes the host 106 to send the access requests for the data to the first virtual storage device 110, which remains a member of the zone as part of the first migration device 108. As such, the host 106 preferably uses multipathing software that detects virtual storage devices. Considering another approach, the access requests may be intercepted by an access request controller of the virtual storage device during transmission from the host 106 to the source storage device 102. The requests then may be redirected by any fabric element of network 113 (e.g., a switch (not specifically shown in FIG. 1) forming part of network 113) such that the first migration device 108 or the first virtual storage device 110 receives the requests.

The first virtual storage device 110 is configured, e.g., by software running on a processor of first migration device 108, to acquire a “lock” on the data during migration. The lock is a permission setting that allows the first virtual storage device 110 exclusive control over the locked data absent the presence of another lock. A lock is, for example, a flag or other type of value without which the data associated with the lock cannot be accessed and/or changed. With the data locked, write commands initiated by the host 106 (“host writes”) cannot corrupt the data during copying. The first virtual storage device 110 is further configured to receive via network 113 write access requests for the data being migrated, hold the write access requests, and upon release of the lock, send the held write access requests to the source storage device 102 and the target storage device 104 without interrupting access to the data by the host 106. To make sure that the held write access requests do not expire (as might otherwise be the case due to a timer associated with each access request) and interrupt host access, any locks on the data, including the lock acquired by the first virtual storage device 110, may be released by the first migration device 108 such that the held write access requests may be sent to the source storage device 102 and target storage device 104. Because the migration is atomic, if any write access requests on a given range are received by first virtual storage device 110 before migration of that particular range begins, the write access requests will be performed before that data range is migrated. If the write access requests for that particular range are received after the migration begins, such write access requests will be held to be performed once the migration ends. Preferably, the speed of copying the data by the first migration device 108 allows for no interruption in access to the data by the host 106 should the host 106 request the data at the precise time of migration. However, should the request be in danger of expiring, e.g. timing out, a step of cancelling the lock is preferably invoked by the migration device 108 such that migration and host access are unaffected. Locking the data and holding the write access requests ensures that the data on the source storage device 102 is consistent with the data on the target storage device 104 during and after the migration. If no host requires access to the data, e.g. all hosts are disabled during the migration, the first migration device 108 does not lock the data, and performs a fast copy, allowing the migration of several terabytes of data per hour across multiple target storage devices 104.

Preferably, the data is not subject to a second lock (usually acquired by a host) upon acquisition of the lock (acquired by the first migration device). Performing a check for a second lock (e.g., by the first migration device 108) ensures that any write access requests submitted before a migration command is submitted are fully performed before the migration.

Considering a different approach, in order to minimize possible conflicts, the first virtual storage device 110 is configured to acquire a lock on only a portion of the data during migration of the portion. A portion of the data includes some, but not all, of the data to be migrated. Also, the portion size is adjustable by, for example, a network administrator via a host device 106. Acquiring a lock on only a portion of the data to be migrated, and only during the copying of the portion, allows the remainder of the data to be accessed by the host 106 during the copying of the portion, decreasing the likelihood that the host 106 should request access to the portion at the precise time the portion is being copied. As such, the first virtual storage device 110 is further configured to send write access requests received by the first virtual storage device 110 via network 113, for data not subject to the lock, to the source storage device 102 and the target storage device 104. Preferably, the first virtual storage device 110 is configured to select the portion such that access to the data by the host 106 is not interrupted.

Similar to the previously discussed approach, the portion of data to be migrated is not subject to a second lock upon acquisition of the lock. Performing (e.g., by migration device 108) a check for a second lock ensures that any write access requests submitted before a migration command is submitted are fully performed before the migration. Also similar to the previously discussed approach, the first virtual storage device 110 is further configured to hold write access requests received by the first virtual storage device 110 for the portion, and upon release of the lock by the first migration device 108, send the held write access requests to the source storage device 102 and the target storage device 104 without interrupting access to the data by the host 106 in order to maintain consistent data between the two devices 102, 104 during and after the migration of the portion.

As an example, the size of the portion may be equal to two megabytes, possibly out of a larger block of data (100 megabytes, 1 terabyte, etc.) to be migrated and re-keyed. Accordingly, after one two-megabyte portion of all the data to be migrated is locked and copied, another two-megabyte portion of the data is locked and copied. The size restriction is adjustable, and should be adjusted such that no interruption of the access to the data is experienced by the host 106. For example, the size restriction may be adjusted to one megabyte. As such, the write access request to a one-megabyte portion being migrated would take less time to complete than if the size restriction was two megabytes because the migration of one megabyte takes less time than the migration of two megabytes. However, the latency of the write access requests is minimal even considering the possibility of a write access request occurring concurrently with migration of the portion. Even so, should the request be in danger of expiring, e.g. timing out, the ability to cancel the lock is preferably invoked by the first migration device 108 such that the held write access requests may be sent to the source storage device 102 and target storage device 104 and such that migration and host access are unaffected.

In yet a different approach, the system 100 includes a second migration device 114 coupled to the source storage device 102 and the target storage device 104 as shown in FIG. 1. In at least one embodiment, the second migration device 114 comprises a network device such as a switch, PC-based appliance, or other type of network device. Similar to the above, the second migration device 114 includes a second virtual storage device 116 created by software running on the second migration device 114, and the second virtual storage device 116 is configured to receive access requests for the data from the host 106 during data migration. In this approach, the first virtual storage device 110 is configured to fail over to the second virtual storage device 116 upon an error (e.g., detected via heartbeat mechanism as noted above), e.g., a migration error, read error, write error, hardware error, etc. The first migration device 108 and second migration device 114 are configured to be coupled to and decoupled from the source storage device 102 and the target storage device 104 without interrupting access to the data by the host 106. In at least one embodiment, the second migration device 114 is a Fibre Channel switch, a Fibre Channel over Ethernet switch, or other type of device.

Despite only the first migration device 108 performing the migration in this approach, absent an error, both the second virtual storage device 116 and the first virtual storage device 110 are configured to send the write access requests to the source storage device 102 and the target storage device 104.

Considering another approach, the second migration device 114 is configured to migrate the data from the source storage device 102 to the target storage device 104 in conjunction with the first migration device 108. When both migration devices 108, 114 perform the migration, both migration devices 108, 114 read data from the source storage device 102 and write to the target storage device 104. If the data is encrypted, both migration devices 108, 114 are configured to read the encrypted data from the source storage device 102, decrypt the encrypted data, re-key the data and write the newly encrypted data to the target storage device 104. As previously discussed, the migration of data may occur as a whole, or the migration may be divided into two or more portions, with each migration device 108, 114 responsible for migrating different portions of a larger data set on source storage device 102 to target storage device 104. The migration task may be split equally by, for example, a network administrator using host device 106, among the participating migration devices 108, 114, or in unequal shares, depending, for instance, on the respective utilizations of the migration devices, on other tasks, device speeds, etc.

Accordingly, each virtual storage device 110, 116 is configured to acquire a lock on the portion of the data it migrates so that each virtual storage device 110, 116 may receive and hold write access requests from the host 106 for its respective portion. Specifically, the first virtual storage device 110 is configured to acquire a lock on a first portion of the data during copying such that the first virtual storage device 110 is capable of receiving and holding write access requests for the first portion, the first portion being migrated by the first migration device 108. Also, the second virtual storage device 116 is configured to acquire a lock on a second portion of the data during copying such that the second virtual storage device 116 is capable of receiving and holding the write access requests for the second portion, the second portion being migrated by the second migration device 114. The first virtual storage device 110 is configured to send the write access requests for the first portion to both the source storage device 102 and the target storage device 104 upon release of the corresponding lock. Similarly, the second virtual storage device 116 is configured to send the write access requests for the second portion to both the source storage device 102 and the target storage device 104 upon release of the corresponding lock.

Preferably, such actions are performed by the migration devices 108 and/or 114 without interrupting access to the data by the host 106. Similar to the previously described approaches, the first portion migrated by first migration device 108 and the second portion migrated by second migration device 114 are preferably not subject to a host lock upon acquisition of the migration locks. By having first and second migration devices 108, 114 perform a check for a host lock before beginning to migrate the data ensures that any write access requests submitted before a migration command is submitted are fully performed before the migration. The size of the first portion, as an example, is equal to two megabytes and the size of the second portion is equal to two megabytes. Such size restriction is adjustable, and should be adjusted such that no interruption of the access to the data is experienced by the host 106. Even so, should the request be in danger of expiring, e.g. timing out, the ability of first and second migration devices 108, 114 to cancel the lock is preferably invoked such that the held write access requests may be sent to the source storage device 102 and target storage device 104 and such that migration and host access are unaffected.

Considering another approach, the system 100 further includes multiple source storage devices 102. The multiple source storage devices 102 can include, for example, greater than one hundred individual source storage devices 102. Additionally, the first migration device 108 includes a first set of multiple virtual storage devices 110 corresponding to the multiple source storage devices 102, and the second migration device 114 includes a second set of multiple virtual storage devices 116 corresponding to the multiple source storage devices 102. Preferably, the ratio between the number of the first set of virtual storage devices 110 and the multiple source storage devices 102 is one-to-one. Similarly, the ratio between the number of the second set of virtual storage devices 116 and the multiple source storage devices 102 is one-to-one.

Each virtual storage device 110, 116 includes a parent volume representing an entire source storage device. While migration of the entire source storage device 102 is possible, the parent volume of data to be migrated can be broken into multiple subvolumes, one for each portion of the source storage device 102 that is to be migrated as well.

Considering another approach, the first migration device 108 includes a first set of virtual storage devices 110, each virtual storage device out of the first set of virtual storage devices 110 corresponding to a data path between the first migration device 108 and the multiple source storage devices 102. The second migration device 114 includes a second set of virtual storage devices 116, each virtual storage device out of the second set of virtual storage devices 116 corresponding to a data path between the second migration device 114 and the multiple source storage devices 102. Each data path between the first migration device 108, or second migration device 114, and the multiple source storage devices 102 is represented by a port on the one of the multiple source storage devices 102 in combination with a logical unit number. Thus, data paths are not only physical links between the migration devices 108, 114 and the source storage devices 102 but may also be virtual routes taken by communication between migration devices 108, 114 and source/target storage devices 102, 104. As such, each physical link includes more than one data path. Also, the host 106 is configured to access the data during the migration without host configuration changes.

As those having ordinary skill in the art will appreciate, the above described approaches can be used in any number of combinations, and all such combinations are within the scope of this disclosure.

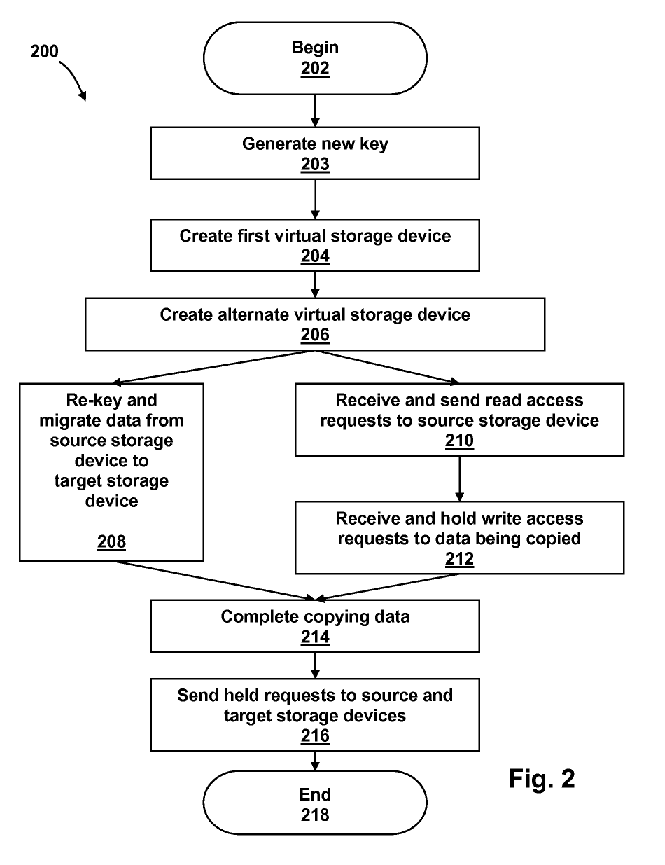

FIG. 2 illustrates an exemplary method 200 for data migration from a source storage device to a target storage device, beginning at 202 and ending at 218, which may be performed in the first and/or second migration devices 108,114. In at least one embodiment, some of the steps are performed concurrently or simultaneously or in a different order from that shown in FIG. 2.

In one embodiment, migration is initiated at 202 by, for example, the host 106 sending a migration command via network 113 to the first migration device 108. At 203, the first migration device 108 generates a new encryption key to be used to re-key the data to be migrated. Generating an encryption key comprises, for example, using a pseudo-random number generator or some other structure in first migration device 108 to generate a random or pseudo-random value to be used as the new key, or retrieving an externally generated key. The newly generated key is stored in or by the first migration device 108.

At 204, a first virtual storage device 110 is created by the first migration device 108. The first virtual storage device 110 is configured to make the data being migrated made available to the host 106 by receiving write access requests for data via network 113 from a host 106 during migration of the data and sending via network 113 the write access requests to the source storage device 102 and to the target storage device 104.

At 206, an alternate storage device 112 is created by the first migration device 108. The alternate virtual storage device 112 is configured to receive write access requests for data 106 from a host during migration of the data and send the write access requests to the source storage device 102 and the target storage device 104. The first virtual storage device 110 is configured to fail over to the alternate virtual storage device 112 upon an error, e.g., a migration error, read error, write error, etc.

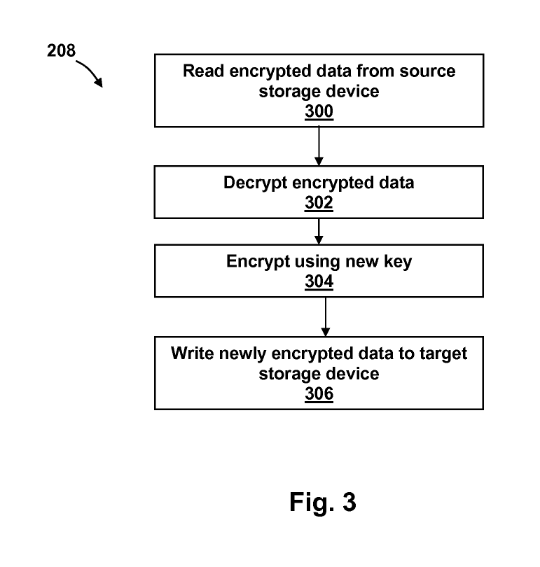

At 208, the data is migrated and re-keyed during migration. As illustrated in FIG. 3, re-keying the data being migrated (208) includes reading (300) the encrypted data from the source storage device 102, decrypting (302) such data using a suitable key to produce unencrypted data, re-encrypting (304) such data with the newly generated key from 203 and writing (306) the newly encrypted data (re-keyed data) to the target storage device 104. The key used by the migration device(s) 108, 114 to decrypt the data may be the same key used to encrypt the data in the first place in the case of symmetric encryption. If asymmetric encryption (e.g., public key, private key encryption) is used, then the key used to decrypt the data may be different than the key used to decrypt the data. The key used to decrypt the data preferably is stored in the first migration device 108 or otherwise made accessible to the first migration device 108.

The key used to re-key the data may also be used to store new data or update the data after the migration completes. For example, the key generated at 203 of FIG. 2 may be provided to the host 106 so that the host can encrypt new data to be stored on the target storage device 104.

FIG. 2 illustrates at 208-212 that data is re-keyed and migrated from the source storage device 102 to the target storage device 104, while concurrently the data remains on-line and available for access by a host 106. During the migration process (i.e., 208) at 210, read access requests received at the first virtual storage device 110 from the host 106 are preferably sent to the source storage device 102. At 212, during migration write access requests for the data are received at the first virtual storage device 110 device from the host 106. These write access requests are ultimately sent from the first virtual storage device 110 to the source storage device 102 and the target storage device 104 as explained above. For example, in some embodiments at 212 the write access requests are temporarily held (e.g., temporarily prevented from being performed) during copying of the data because a lock is acquired on the data.

Data migration and re-keying ends at 214 at which time the lock (if a lock asserted) is released, and any held write access requests are sent by the first virtual storage device 110 via network 114 to the source storage device 102 and the target storage device 104 at 216. Preferably, the write access requests are sent before they expire, e.g. time out, and the lock is released as necessary.

Preferably, the source storage device 102 is disassociated from the host 106 such that the host 106 sends the access requests for the data to the first virtual storage device 110. For example, a Fibre Channel fabric includes the source storage device 102, the target storage device 104, and the host 106. As such, migrating the data further includes removing the source storage device 102 from a Fibre Channel zone such that the host 106 sends the access requests for the data to the first virtual storage device 110, the host 106 being a member of the Fibre Channel zone. In at least one embodiment, the above steps apply to portions of the data, and the size of the portion is configurable, e.g., the size of the portion may be equal to two megabytes or one megabyte.

Considering a different approach, a second (also referred to herein as “alternate”) virtual storage device 112 is created. Similar to the above approaches, the second virtual storage device 112 can be used as a fail over or in conjunction with the first virtual storage device 110. Should an error occur on the path between the host and a first virtual storage device 110, a fail over path is chosen. The fail over path is either the path between the host 106 and the alternate virtual storage device (on the same migration device) or the path between the host 106 and the second virtual storage device 112 (on a different migration device). If the first virtual storage device 110 encounters a software error, the alternate virtual storage device 112 is preferably chosen. If the first migration device 108 encounters a hardware error or the data path to the first virtual storage device 110 is in error, the data path to the alternate virtual storage device 112 is probably in error as well, and the alternate virtual storage device 112 is preferably chosen. Should an error occur on the path between the first virtual storage device 108 and the source storage device 102, another fail over path may be similarly chosen, or if the data requested has already been migrated, the first virtual storage device 110 may access the data on the target storage device 104.

Should an error occur on the path between the first virtual storage device and the target storage device, another path may be similarly chosen. However, in such a case, if a write access request has been successfully performed by the source storage device 102 (but not the target storage 104 device due to the error), a successful write acknowledgment may still be returned by, for example, the first migration device 108 to the host because a new migration, from the source storage device to the target storage device, of the relevant portion of the data is initialized either on a different path or the same path at a later time, preferably when the path is healthy again.

Preferably, when the first virtual storage device 110 fails over to the second virtual storage device 112 on a different migration device, the migration status is synchronized via messages from the first migration device 108 to the second migration device 114. In case of a failed portion of migration, the second migration device 114 preferably attempts the migration as well. Should the first migration device 108 suffer hardware failure, the second migration device 114 preferably verifies the failure before assuming migration responsibilities. Such verification can be made using “keys” on the target storage device 104. A key is a particular sequence of data written to the target storage device. When both migration devices 108, 114 are functioning normally, they will write the same key onto the target storage device when accessing the target storage device. In order for the second migration device to verify failure of the first migration device, the second migration device uses an alternate key instead of the original key. If the first migration device has not failed, it will overwrite this alternate key with the original key upon accessing the target storage device. Upon recognizing the failure to overwrite, the second migration device can safely assume that the first migration device has indeed failed, and may take migration responsibility. Such a key system can be implemented using Small Computer System Interface (“SCSI”) protocol.

Preferably, an audio or visual alert is triggered upon successful migration of the data or upon an error. Additionally, audio or visual alerts may be triggered upon successful completion of any action described herein, upon unsuccessful actions described herein, and upon errors.

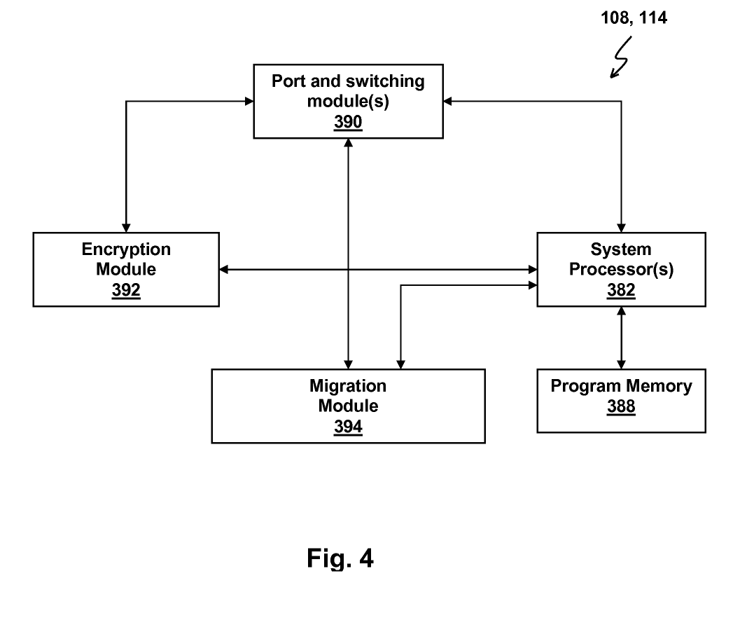

In some embodiments, each migration device 108, 114 is implemented according to the embodiment shown in FIG. 4. As shown, each migration device includes one or more system processors 382 coupled to a program memory 388 which may comprise non-volatile and/or volatile memory on executable software can be stored. The system processor(s) 382 provide basic control and management functions, perform higher level functions, and handle exceptions and unusual cases. The embodiment of FIG. 4 also includes one or more port and switching modules 390, an encryption module 392, and a migration module 394 coupled together as shown. The various devices and modules are configured to present a virtual storage device (e.g., virtual storage devices 110, 116) to external logic. Either of the system processor 382 or the migration module 394 also functions as an access request controller to enable write accesses to data being migrated to continue without having to take the storage unit containing such data off-line as explained above.

The system processor(s) 382 couples to the port and switching modules 390 which provide connections to external devices such as target storage devices 102, 104 as well as the host computer 106. The port and switching module(s) 382 provide switching between external ports and the encryption and migration modules 392, 394 and the system processor(s) 382.

The encryption and migration modules 392, 394 provide basic hardware and dedicated firmware support for performing decryption, encryption, and migration tasks at line speeds. Each of the encryption and migration modules 392, 394 may comprise their own processors. In accordance with various embodiments, the system processors 382 and/or the encryption module 392 generate a new encryption key for a migration process as explained above. Once generated, the key may be stored in the program memory 388 and/or on the encryption module 392 or migration module 394. The program memory 388, or other storage, thus may contain the newly generated key as well as the key that is used to decrypt the data during the migration process.

The system processor(s) 382 causes the migration module 394 to read the data from the source storage device 102 and provide such data to the encryption module 392 which is responsible for decrypting the data using the appropriate key (e.g., read from program memory 388 or received externally) and then re-encrypting the data using the new key. Once re-encrypted, the encryption module 392 provides the data back to the migration module 394 which then writes the newly encrypted data to the target storage device 104.

In some embodiments, the port and switching modules 390 handles write requests that target data being migrated and re-keyed as described above. In other embodiments, the system processor 382 or the migration module 394 handles such write requests. For example, an incoming write request is passed from the port and switching modules 390 to the system processor 382 which acknowledges the request after checking with the storage device targeted by the write request. The system processor 382 in some embodiments may communicate with the migration module 394 to determine whether the scope of the write request is to a block of data actively being migrated. If the request is to a block of data actively being migrated, then the request is held until the migration of that particular block of data is complete; then the request is permitted to complete as explained previously. If a write request does not target a block of data actively being migrated, although other blocks of data on the same storage device are being actively migrated, then the system processor 382 permits the write request to go through to the appropriate storage device.

Depending on the desired line speeds, more or less can be done in hardware, assisting the dedicated firmware and system processor. It is understood that FIG. 4 provides an example embodiment and the various functions and modules can be reorganized or combined depending on the particular characteristics and needs of a given design and situation.

In at least one embodiment, the components depicted in FIG. 4 are located on a switch, which may comprise a Fibre Channel switch or a Fibre Channel over Ethernet switch, or some other technology switch.

The above disclosure is meant to be illustrative of the principles and various embodiment of the present invention. Numerous variations and modifications will become apparent to those skilled in the art once the above disclosure is fully appreciated. It is intended that the following claims be interpreted to embrace all variations and modifications.

We claim:

1. A method of migrating data, comprising:
migrating source encrypted data, by a migration device, from a source storage device to a target storage device;
re-keying, by the migration device, while migrating said source encrypted data; and
while re-keying and migrating said source encrypted data, performing, by the migration device, an access request to said source encrypted data apart from said migrating and re-keying.

2. The method of claim 1 wherein re-keying while migrating said source encrypted data comprises:
decrypting, by the migration device, said source encrypted data to form unencrypted data; and
encrypting, by the migration device, said unencrypted data with a new key to form newly encrypted data, said new key being different than a key used to encrypt said source encrypted data.

3. The method of claim 2 wherein migrating said source encrypted data comprises writing, by the migration device, said newly encrypted data to a target storage device.

4. The method of claim 2 further comprising generating, by the migration device, said new key upon beginning to migrate.

5. A device, comprising:
a migration module configured to migrate encrypted data from a first storage location device to a second storage device;
an encryption module coupled to said migration software, said encryption module configured to re-key said encrypted data as said encrypted data is being migrated; and
an access request controller coupled to said encryption module, said access request controller configured to receive write access requests for the encrypted data from a host while said data is being rekeyed and migrated and to send the write access requests to the first storage device and the second storage device.

6. The device of claim 5 wherein the encryption module is configured to re-key said encrypted data by decrypting said encrypted data from the first storage device to form unencrypted data and encrypting said unencrypted data with a new key to form newly encrypted data, said new key being different than a key used to encrypt said encrypted data.

7. The device of claim 6 wherein one of the access request controller or the encryption module generates the new key for use during migrating the encrypted data.

8. The device of claim 5 wherein the access request controller acquires a lock on the encrypted data being migrated and holds a write access request that targets said encrypted data until migration of said encrypted data is complete.

9. The device claim 5 wherein, upon said migration being complete, the access request controller is configured to release said lock and to send the write access request on hold to the first storage device and the second storage device.

10. A method of migrating data, comprising:
migrating source encrypted data, by a migration device, from a source storage device to a target storage device;
re-keying, by the migration device, while migrating said source encrypted data; and
while re-keying and migrating said source encrypted data, receiving and holding write access requests to said source encrypted data.

11. The method of claim 10 wherein re-keying while migrating said source encrypted data comprises:
decrypting, by the migration device, said source encrypted data to form unencrypted data; and
encrypting, by the migration device, said unencrypted data with a new key to form newly encrypted data, said new key being different than a key used to encrypt said source encrypted data.

12. The method of claim 11 wherein migrating said source encrypted data comprises writing, by the migration device, said newly encrypted data to a target storage device.

13. The method of claim 11 further comprising generating, by the migration device, said new key upon beginning to migrate.

14. The method of claim 10 wherein, upon completing the migrating, releasing, by the migration device, any write access requests on hold.
